(19) United States
(12) Patent Application Publication
(10) Pub. No.: US 2020/0371310 A1
(43) Pub. Date: Nov. 26, 2020

(54) GIMBAL, PHOTOGRAPHING ASSEMBLY AND UNMANNED AERIAL VEHICLE

(71) Applicant: AUTEL ROBOTICS CO., LTD., Shenzhen (CN)

(72) Inventor: Chun YU, Shenzhen (CN)

(21) Appl. No.: 16/988,295

(22) Filed: Aug. 7, 2020

Related U.S. Application Data
(63) Continuation of application No. PCT/CN2018/115451, filed on Nov. 14, 2018.

(30) Foreign Application Priority Data
Feb. 9, 2018 (CN) 201810135901X

(51) Int. Cl. G02B 7/10; G03B 17/12

(52) U.S. Cl. CPC G02B 7/10; B64C 39/024; G03B 17/12

(57) ABSTRACT

The present invention relates to the field of aircrafts, and provides a gimbal, a photographing assembly and an unmanned aerial vehicle (UAV). The gimbal includes: a first motor, a lens barrel, a second motor, a support assembly and a wire. The first motor is configured to carry a photographing device and drive the photographing device to rotate around a first rotation axis. The first motor is mounted to the lens barrel. The second motor is mounted to the lens barrel and is configured to drive the lens barrel, the first motor and the photographing device to rotate around a second rotation axis, and the first rotation axis is perpendicular to the second rotation axis. The lens barrel and the second motor are both mounted to the support assembly. The wire penetrates through the support assembly and the lens barrel, and is electrically connected to the first motor and the photographing device. The wire of the present invention penetrates through the support assembly and the lens barrel, so that occupied space of the gimbal can be saved, and the gimbal has a compact structure and a small volume.

This application is a continuation application of International Application No. PCT/CN2018/115451, filed on Nov. 14, 2018, which claims priority of Chinese Patent Application No. 201810135901.X, filed on Feb. 9, 2018, which is incorporated herein by reference in its entirely.

### BACKGROUND

### Technical Field

The present invention relates to the field of aerial vehicles, and in particular, to a gimbal, a photographing assembly that has the gimbal and an unmanned aerial vehicle (UAV) that has the photographing assembly.

### Related Art

An unmanned aerial vehicle (UAV for short) is a new concept device under rapid development, which has the advantages of maneuverability, quick response, unmanned operation and low operation requirements. The UAV carries a plurality of types of sensors or photographing devices through a gimbal, to implement real-time image transmission and detection of high-risk areas, which is a powerful complement to satellite remote sensing and conventional aerial remote sensing.

For convenience of carrying for a user, miniaturization of the UAV is a development trend. Despite miniaturization, functions of the UAV also need to be maintained. The gimbal is particularly important as a part of a photographing system of the UAV, and a size of the gimbal is directly related to whether a volume of the UAV may be made small. However, the current gimbal has a complex structure, resulting in a relatively large volume.

### SUMMARY

In order to resolve the foregoing technical problem, embodiments of the present invention provides a gimbal with a compact structure, a photographing assembly that has the gimbal and an unmanned aerial vehicle (UAV) that has the photographing assembly.

The embodiments of the present invention adopt the following technical solution to resolve the technical problem.

A gimbal, including:

a first motor configured to carry a photographing device and drive the photographing device to rotate around a first rotation axis;

a lens barrel, the first motor being mounted to the lens barrel;

a second motor mounted to the lens barrel and configured to drive the lens barrel, the first motor and the photographing device to rotate around a second rotation axis, and the first rotation axis being perpendicular to the second rotation axis;

a support assembly, the lens barrel and the second motor being both mounted to the support assembly; and

a wire penetrating through the support assembly and the lens barrel and electrically connected to the first motor and the photographing device.

Optionally, the first motor is accommodated in the lens barrel.

Optionally, the support member includes a support member and a connecting member,

the connecting member being movably mounted to the support member and being fixedly mounted to the lens barrel, and the connecting member and the lens barrel being capable of rotating around the second rotation axis relative to the support member; and

the second motor being fixedly mounted to the support member.

Optionally, the lens barrel is provided with a first wiring hole;

the support member is provided with a wiring channel;

the connecting member is provided with a second wiring hole, the second wiring hole being respectively in communication with the first wiring hole and the wiring channel; and

the wire sequentially penetrates through the wiring channel, and then the second wiring hole and the first wiring hole enter the lens barrel.

Optionally, the support member includes a support body, a first support arm and a second support arm,

the first support arm and the second support arm respectively extending from two opposite sides of the support body;

the second motor being fixedly mounted to the first support arm; and

the connecting member being movably mounted to the second support arm, and the connecting member and the lens barrel being capable of rotating around the second rotation axis relative to the second support arm.

Optionally, the second support arm is provided with a mounting hole; and

the connecting member includes a body portion and an extending portion,

the body portion being fixedly mounted to the lens barrel; and

the extending portion extending from the body portion, being inserted into the mounting hole and being capable of rotating around the second rotation axis relative to the second support arm in the mounting hole.

Optionally, the body portion and the extending portion are both hollow cylinders, and a central axis of the body portion and a central axis of the extending portion both overlap with the second rotation axis.

Optionally, an outer contour of the lens barrel is cylindrical, and a central axis of the lens barrel overlaps with the second rotation axis.

Optionally, the lens barrel includes a first barrel body and a second barrel body, the first motor being fixedly mounted to the first barrel body, and the first barrel body being engaged with the second barrel body.

Optionally, the first motor includes a first rotating portion and a first fixing portion,

the first rotating portion being movably connected to the first fixing portion and being fixedly mounted to the lens barrel; and

the first fixing portion being configured to carry the photographing device, and being capable of rotating around the first rotation axis together with the photographing device relative to the first rotating portion.

Optionally, the second motor is disposed outside the lens barrel and includes

a second rotating portion and a second fixing portion,

the second rotating portion being movably connected to the second fixing portion, and the second rotating portion being mounted to the support assembly; and

the second fixing portion being mounted to the lens barrel and being capable of rotating around the second rotation axis together with the lens barrel, the first motor and the photographing device relative to the second rotating portion.

Optionally, the gimbal further includes a third motor, the support assembly being mounted to the third motor, the third motor being configured to drive the support assembly, and the second motor, the first motor, the lens barrel and the photographing device to rotate around a third rotation axis, and the third rotation axis being perpendicular to the first rotation axis and the second rotation axis.

Optionally, the third motor includes a third rotating portion and a third fixing portion,

the third rotating portion being movably connected to the third fixing portion, and the third fixing portion being mounted to the support assembly and being configured to drive the support assembly, the second motor, the first motor, the lens barrel and the photographing device to rotate around the third rotation axis.

Optionally, the gimbal further includes a shock-absorbing assembly, the third rotating portion being fixedly mounted to the shock-absorbing assembly.

Optionally, the shock-absorbing assembly includes a fixing member, a mounting member and a shock-absorbing member,

the fixing member being mounted to the third rotating portion;

the mounting member being mounted to one end of the fixing member; and

the shock-absorbing member being mounted to the mounting member.

Optionally, the fixing member is a hollow cylinder and sleeved on the third rotating portion.

Optionally, the shock-absorbing member is a shock-absorbing strut or a shock-absorbing ball.

Optionally, the mounting member is square plate-shaped; and

four shock-absorbing members are fixedly mounted to four corners of the mounting member.

The embodiments of the present invention further adopt the following technical solution to resolve the technical problem.

A photographing assembly includes a photographing device and the foregoing gimbal, the photographing device being mounted to the first motor.

Optionally, the photographing device includes a lens mount and at least one lens,

the at least one lens being fixedly mounted to the lens mount; and

the lens mount being mounted to the first motor.

The embodiments of the present invention further adopt the following technical solution to resolve the technical problem.

An unmanned aerial vehicle includes a fuselage and the foregoing photographing assembly, the shock-absorbing assembly being mounted to the fuselage.

Compared with the prior art, the wire of the embodiment of the present invention penetrates through the support assembly and the lens barrel, so that occupied space of the gimbal may be saved, and the gimbal has a compact structure and a small volume.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a three-dimensional view of a photographing assembly according to an embodiment of the present invention.

FIG. 2 is a partial exploded view of the photographing assembly shown in FIG. 1.

FIG. 3 is an exploded view of the photographing assembly shown in FIG. 1.

FIG. 4 is an exploded view of the photographing assembly shown in FIG. 1 from another perspective.

FIG. 5 is an exploded view of the photographing assembly shown in FIG. 1 from still another perspective.

### DETAILED DESCRIPTION

For ease of understanding the present invention, the present invention is described in more detail below with reference to the accompanying drawings and specific embodiments. It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. The terms “vertical”, “horizontal”, “left”, “right”, “inner”, “outside”, and similar expressions are merely used for an illustrative purpose.

Unless otherwise defined, meanings of all technical and scientific terms used in this specification are the same as that usually understood by a person skilled in the technical field to which the present invention belongs. Terms used in the specification of the present invention are merely intended to describe objectives of the specific embodiment, and are not intended to limit the present invention. A term “and/or” used in this specification includes any or all combinations of one or more related listed items.

In addition, technical features involved in different embodiments of the present invention described below may be combined together if there is no conflict.

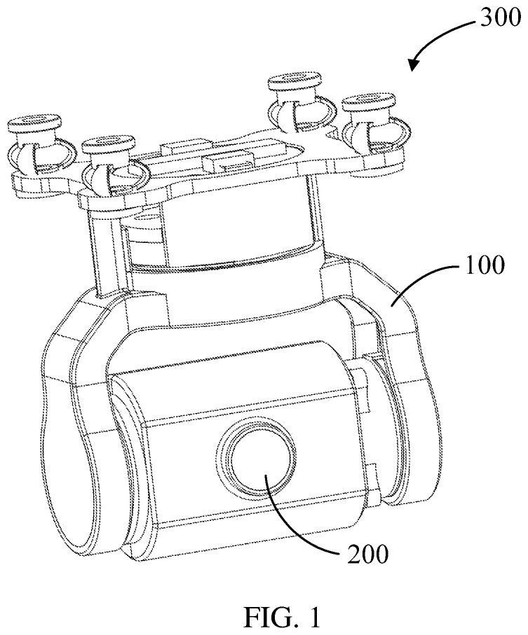

Referring to FIG. 1, a photographing assembly 300 according to an embodiment of the present invention is mounted to a fuselage of an unmanned aerial vehicle (UAV). The photographing assembly 300 includes a gimbal 100 and a photographing device 200. The photographing device 200 is mounted to the gimbal 100, is configured to capture an image and includes at least one lens. The gimbal 100 is mounted to the fuselage of the UAV and is used for the photographing device 200 to fixedly or randomly adjust an attitude of the photographing device 200 (for example, change a height, an inclination angle and/or a direction of the photographing device 200), and cause the photographing device 200 to be stably maintained at a set attitude.

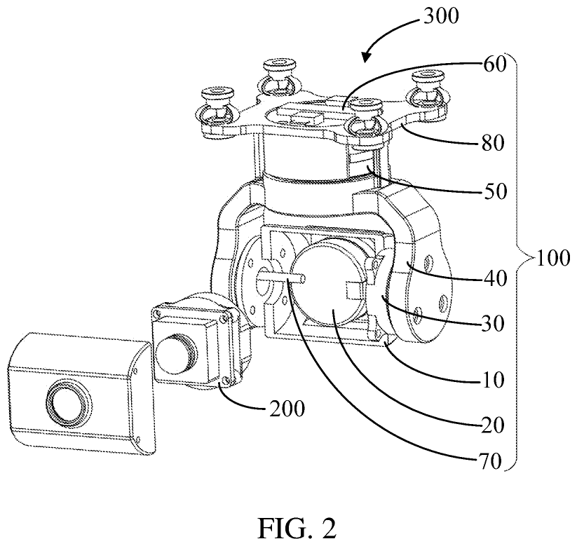

Referring to FIG. 2, the gimbal 100 includes a lens barrel 10, a first motor 20, a second motor 30, a support assembly 40, a third motor 50, a control circuit board 60, a wire 70 and a shock-absorbing assembly 80. The first motor 20 carries the photographing device 200 and is configured to drive the photographing device 200 to rotate around a first rotation axis. The first motor 20 is mounted to the lens barrel 10, and the first motor 20 and the photographing device 200 are both accommodated in the lens barrel 10. The second motor 30 is mounted to the lens barrel 10, disposed outside the lens barrel 10 and configured to drive the lens barrel 10, the first motor 20 and the photographing device 200 to rotate around a second rotation axis. One end of the lens barrel 10 is fixedly mounted to the second motor 30, and the other end of the lens barrel 10 is movably mounted to the support assembly 40. The third motor 50 is mounted to the support assembly 40, and is configured to drive the wire 70, the support assembly 40, the second motor 30, the first motor 20, the lens barrel 10 and the photographing device 200 to rotate around a third rotation axis. The control circuit board 60 is electrically connected to the first motor 20, the second motor 30 and the third motor 50, respectively. The wire 70 penetrates through the support assembly 40 and the lens barrel 10, and electrically connects the photographing device 200 and the first motor 20 to the control circuit board 60, so that the photographing device 200 and the first motor 20 can receive a control signal from the control circuit board 60. The control circuit board 60 and the third motor 50 are respectively mounted to the shock-absorbing assembly 80. The shock-absorbing assembly 80 is configured to mount the gimbal 100 to the fuselage of the UAV. The first rotation axis and the second rotation axis are perpendicular to each other, and the third rotation axis is perpendicular to the first rotation axis and the second rotation axis.

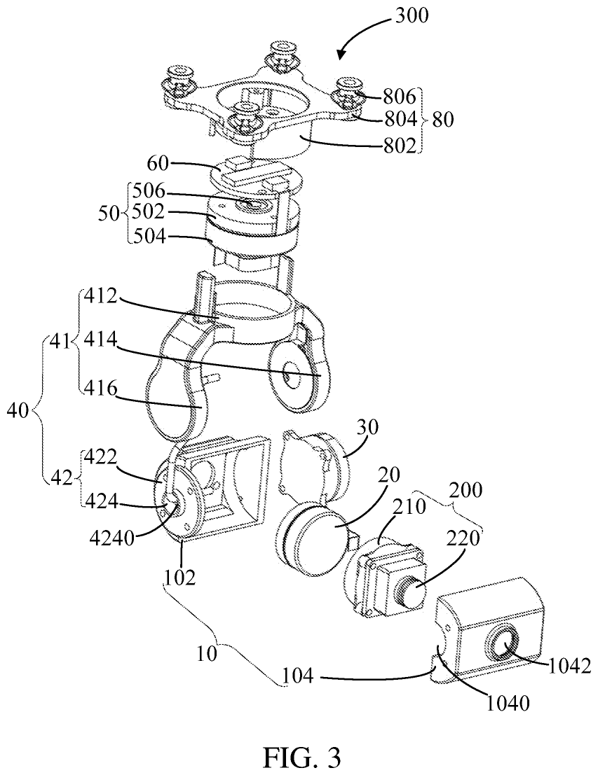

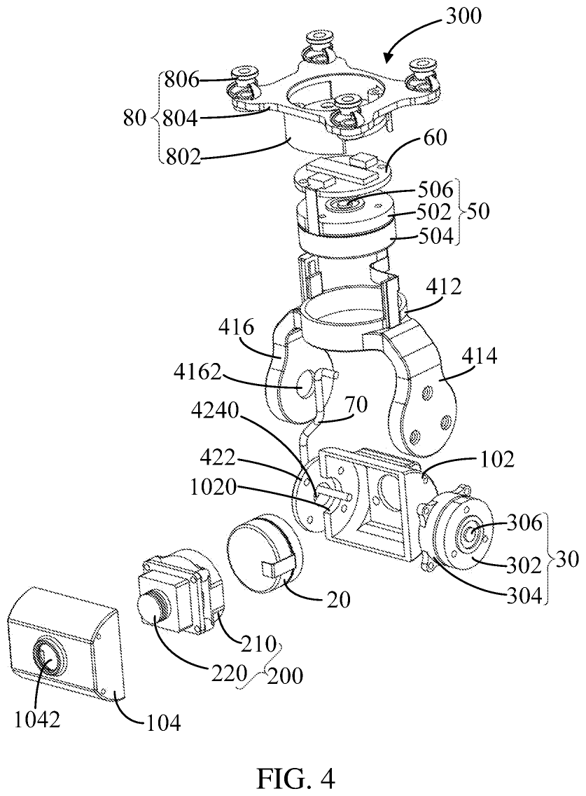

Referring to FIG. 3 and FIG. 4 together, an outer contour of the lens barrel 10 is substantially cylindrical, and a central axis of the lens barrel overlaps with the second rotation axis. The lens barrel 10 includes a first barrel body 102 and a second barrel body 104, and is divided into the first barrel body 102 and the second barrel body 104 by a plane passing through the central axis of the lens barrel. The first barrel body 102 supports the first motor 20 and is provided with a first notch 1020 (see FIG. 4), and the second barrel body 104 is provided with a second notch 1040 and a through hole 1042 (see FIG. 3), the first notch 1020 and the second notch 1040 forming a first wiring hole, the first wiring hole being used to allow the wire 70 to pass through. The through hole 1042 is used to allow a lens of the photographing device 200 to pass through.

In the present embodiment, the lens barrel 10 includes the first barrel body 102 and the second barrel body 104 that are separated. The photographing device 200 may be fixed to the first motor 20 during mounting, then the first motor 20 is fixed to an inner side wall of the first barrel body 102, and finally the second barrel body 104 is engaged with the first barrel body 102, so that the photographing device 200 and the first motor 20 can be mounted into the lens barrel 10 through the first barrel body 102 and the second barrel body 104 that are separated. In addition, the photographing device 200 and the first motor 20 are mounted into the lens barrel 10, so that the structure of the gimbal 100 can be compact, and the moment of inertia of the gimbal 100 is small. Furthermore, an outer contour of the lens barrel 10 is substantially cylindrical, and the central axis of the lens barrel 10 overlaps with the second rotation axis. During rotation around the second rotation axis, the moment of inertia of the lens barrel 10 is small.

It may be understood that in some other embodiments, the lens barrel 10 is not limited to being divided into the first barrel body 102 and the second barrel body 104 by the plane passing through the central axis thereof, or may be divided into two or more parts by adopting other dividing methods according to actual needs, to facilitate the mounting of the photographing device 200 and the first motor 20 into the lens barrel 10.

It may be understood that in some other embodiments, the outer contour of the lens barrel 10 is not limited to a substantially cylindrical shape, which may be changed according to actual needs, as long as the lens barrel can carry the first motor 20 and the photographing device 200 and can be fixedly connected to the second motor 30. For example, the lens barrel 10 may be spherical, ellipsoidal, or the like.

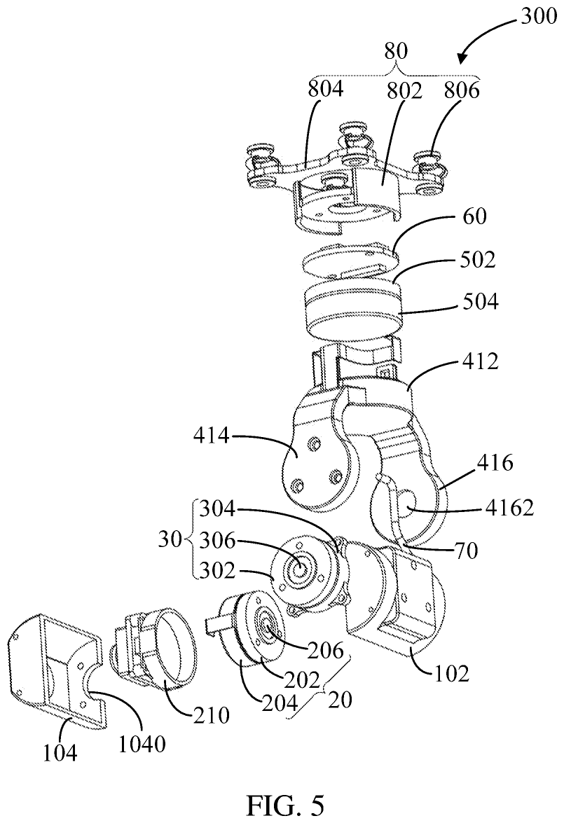

Referring to FIG. 5, the first motor 20 includes a first rotating portion 202, a first fixing portion 204 and a first rotating shaft 206. A central axis of the first rotating shaft 206 overlaps with the first rotation axis. Both the first rotating portion 202 and the first fixing portion 204 are sleeved on the first rotating shaft 206, the first fixing portion 204 is movably mounted to the first rotating shaft 206, the first rotating portion 202 is fixedly mounted to the first rotating shaft 206, and both the first rotating portion 202 and the first rotating shaft 206 may rotate together around the first rotation axis relative to the first fixing portion 204. The first rotating portion 202 is fixedly mounted to the first barrel body 102. The first fixing portion 204 is fixedly connected to the photographing device 200 and configured to drive the photographing device 200 to rotate around the first rotation axis. In the present embodiment, a rotation angle of the first motor 20 ranges from −45 degrees to +45 degrees, that is, the first fixing portion 204 may drive the photographing device 200 to rotate a total of 90 degrees around the first rotation axis. It may be understood that, in some other embodiments, the rotation angle of the first motor 20 may be changed according to actual needs. For example, the rotation angle of the first motor 20 may range from −60 degrees to +60 degrees.

In the present embodiment, the first motor 20 is a roll axis motor, that is, the first rotation axis overlaps with a roll axis. The first motor 20 is a disc-type motor, and the first fixing portion 204 is a stator of the roll axis motor, which includes a support, a bearing, a coil, a circuit board, and the like. The support is disk-shaped, the bearing, the coil, the circuit board, and the like are mounted to the disk-shaped support, and the bearing is sleeved on the first rotating shaft 206. The first rotating portion 202 is a rotor of the roll axis motor, which includes a support plate and a permanent magnet mounted to the support plate. The support plate is disk-shaped, is parallel to the support and fixedly mounted to one end of the first rotating shaft 206. The first motor 20 is a disc-type motor, which has the advantages of a small volume, a light weight, a compact structure and high efficiency, so that the gimbal 100 may have a more compact structure.

It may be understood that, in some other embodiments, the first fixing portion 204 may be a rotor of a roll axis motor, which is fixedly mounted to the first rotating shaft 206 and can rotate together with the first rotating shaft 206 relative to the first rotating portion 202. However, the first rotating portion 202 may be a stator of the roll axis motor, which is movably mounted to the first rotating shaft 206 and can rotate around the first rotating shaft 206.

The second motor 30 includes a second rotating portion 302, a second fixing portion 304 and a second rotating shaft 306. A central axis of the second rotating shaft 306 overlaps with the second rotation axis. Both the second rotating portion 302 and the second fixing portion 304 are sleeved on the second rotating shaft 306, the second fixing portion 304 is movably mounted to the second rotating shaft 306, the second rotating portion 302 is fixedly mounted to the second rotating shaft 306, and both the second rotating portion 302 and the second rotating shaft 306 may rotate together around the second rotation axis relative to the second fixing portion 304. The second rotating portion 302 is fixedly mounted to the support assembly 40. The second fixing portion 304 is fixedly mounted to the lens barrel 10 and may drive the lens barrel 10, the first motor 20 and the photographing device 200 to rotate around the second rotation axis. In the present embodiment, a rotation angle of the second motor 30 ranges from −30 degrees to +120 degrees, that is, the second fixing portion 304 may drive the lens barrel 10, the first motor 20 and the photographing device 200 to rotate a total of 150 degrees around the second rotation axis. It may be understood that, in some other embodiments, the rotation angle of the second motor 30 may be changed according to actual needs. For example, the rotation angle of the second motor 30 may range from −60 degrees to +60 degrees.

In the present embodiment, the second motor 30 is a pitch axis motor, that is, the second rotation axis overlaps with a pitch axis. The second motor 30 is a disc-type motor, and the second fixing portion 304 is a stator of the roll axis motor, which includes a support, a bearing, a coil, a circuit board, and the like. The support is disk-shaped, the bearing, the coil, the circuit board, and the like are mounted to the disk-shaped support, and the bearing is sleeved on the second rotating shaft 306. The second rotating portion 302 is a rotor of the pitch axis motor, which includes a support plate and a permanent magnet mounted to the support plate. The support plate is disk-shaped, is parallel to the support and fixedly mounted to one end of the second rotating shaft 306. The second motor 30 is a disc-type motor, which has the advantages of a small volume, a light weight, a compact structure and high efficiency, so that the gimbal 100 may have a more compact structure.

It may be understood that, in some other embodiments, the second fixing portion 304 may be a rotor of the pitch axis motor, which is fixedly mounted to the second rotating shaft 306 and can rotate together with the second rotating shaft 306 relative to the second rotating portion 302. However, the second rotating portion 302 may be a stator of the pitch axis motor, which is movably mounted to the second rotating shaft 306 and can rotate around the second rotating shaft 306.

Referring to FIG. 3 and FIG. 4 again, the support assembly 40 includes a support member 41 and a connecting member 42, the connecting member 42 being movably mounted to the support member 41 and being capable of rotating around the second rotation axis relative to the support member 41.

The support member 41 is roughly “U-shaped” and includes a support body, a first support arm 414 and a second support arm 416, the first support arm 414 and the second support arm 416 respectively extending from two opposite sides of the support body 412.

The support body 412 is a hollow cylinder and is sleeved on the third motor 50.

The first support arm 414 is a hollow structure and is used to reduce a weight of the gimbal 100, and a flexible printed circuit board (FPCB) cable may be mounted in the first support arm 414, the flexible circuit board cable being used to electrically connect the second motor 30 to the control circuit board 60. The second rotating portion 302 is fixedly mounted to the first support arm 414.

The second support arm 416 is also a hollow structure and is used to reduce the weight of the gimbal 100, and the second support arm 416 is provided with a wiring channel, the wiring channel being used to accommodate the wire 70. The second support arm 416 is provided with a mounting hole 4162 for partially accommodating the connecting member 42.

The connecting member 42 is fixedly mounted to the lens barrel 10 and is provided with a second wiring hole 4240, the second wiring hole 4240 penetrating through the connecting member 42 and being respectively in communication with the first wiring hole and the wiring channel. The connecting member 42 includes a body portion 422 and an extending portion 424. The body portion 422 is fixedly mounted to the lens barrel 10, which is a hollow cylinder. The extending portion 424 extends from the body portion 422, is inserted into the mounting hole 4162 and is capable of rotating around the second rotation axis relative to the second support arm 416 in the mounting hole 4162, so that the connecting member 42 and the lens barrel 10 can rotate around the second rotation axis relative to the second support arm 416. The extending portion 424 is also a hollow cylinder, which has a diameter less than a diameter of the body portion 422, and a central axis of the body portion 422 and a central axis of the extending portion 424 both overlap with the second rotation axis. In the present embodiment, the second wiring hole 4240 is in communication with the first wiring hole, and is used to allow the wire 70 to pass through and enter the wiring channel to electrically connect the control circuit board 60. Through the wiring channels in communication with each other, the second wiring hole 4240 and the first wiring hole may cause, to be disposed in the gimbal 100, the wire 70 that electrically connects the photographing device 200 and the first motor 20 to the control circuit board 60, to reduce the volume of the gimbal 100.

The third motor 50 includes a third rotating portion 502, a third fixing portion 504 and a third rotating shaft 506. A central axis of the third rotating shaft 506 overlaps with the third rotation axis. Both the third rotating portion 502 and the third fixing portion 504 are sleeved on the third rotating shaft 506, the third fixing portion 504 is movably mounted to the third rotating shaft 506, the third rotating portion 502 is fixedly mounted to the third rotating shaft 506, and both the third rotating portion 502 and the third rotating shaft 506 may rotate together around the third rotation axis relative to the third fixing portion 504. The third rotating portion 502 is fixedly mounted to the shock-absorbing assembly 80. The third fixing portion 504 is fixedly mounted to the support body 412, and the support body 412 is sleeved on the third fixing portion 504. The third fixing portion 504 may drive the wire 70, the support assembly 40, the second motor 30, the first motor 20, the lens barrel 10 and the photographing device 200 to rotate around the third rotation axis. In the present embodiment, a rotation angle of the third motor 50 ranges from −45 degrees to +45 degrees, that is, the third fixing portion 504 may drive the wire 70, the support assembly 40, the second motor 30, the first motor 20, the lens barrel 10 and the photographing device 200 to rotate a total of 90 degrees around the third rotation axis. It may be understood that, in some other embodiments, the rotation angle of the third motor 50 may be changed according to actual needs. For example, the rotation angle of the third motor 50 may range from −60 degrees to +60 degrees.

In the present embodiment, the third motor 50 is a heading axis motor, that is, the third rotation axis overlaps with a heading axis. The third motor 50 is a disc-type motor, and the third fixing portion 504 is a stator of the heading axis motor, which includes a support, a bearing, a coil, a circuit board, and the like. The support is disk-shaped, the bearing, the coil, the circuit board, and the like are mounted to the disk-shaped support, and the bearing is sleeved on the third rotating shaft 506. The third rotating portion 502 is a rotor of the heading axis motor, which includes a support plate and a permanent magnet mounted to the support plate. The support plate is disk-shaped, is parallel to the support and fixedly mounted to one end of the third rotating shaft 506. The third motor 50 is a disc-type motor, which has the advantages of a small volume, a light weight, a compact structure and high efficiency, so that the gimbal 100 may have a more compact structure.

It may be understood that, in some other embodiments, the third fixing portion 504 may be a rotor of the heading axis motor, which is fixedly mounted to the third rotating shaft 506 and can rotate together with the third rotating shaft 506 relative to the third rotating portion 502. However, the third rotating portion 502 may be a stator of the heading axis motor, which is movably mounted to the third rotating shaft 506 and can rotate around the third rotating shaft 506.

The control circuit board 60 is accommodated in the shock-absorbing assembly 80, which is electrically connected to the first motor 20, the second motor 30, the third motor 50 and the photographing device 200, respectively, is configured to control the first motor 20, the second motor 30 and the third motor 50 to operate to adjust an attitude of the photographing device 200, and is further configured to control the photographing device 200 to capture an image.

The wire 70 is an ultra-fine coaxial wire, which sequentially penetrates the wiring channel, the second wiring hole 4240 and the first wiring hole enter the lens barrel 10, and the wire 70 electrically connects the first motor 20 and the photographing device 200 to the control circuit board 60. One end of the wire 70 connected to the control circuit board 60 has a certain redundant length, so that when the third fixing portion 504 drives the wire 70 to rotate, the wire 70 will not be broken. It can be understood that, in some other embodiments, the wire 70 may also be a flexible circuit board cable.

The shock-absorbing assembly 80 includes a fixing member 802, a mounting member 804 and a shock-absorbing member 806.

The fixing member 802 is substantially a hollow cylinder, and the central axis of the fixing member overlaps with the third rotation axis. The fixing member 802 may be made of an elastic material, for example, a plastic material, a rubber material, or the like. The fixing member 802 is sleeved on the control circuit board 60 and the third rotating portion 502, and is fixedly mounted to the third rotating portion 502.

The mounting member 804 is fixedly mounted to one end of the fixing member 802, which is substantially square plate-shaped and may be made of an elastic material, for example, a plastic material, a rubber material, or the like.

The shock-absorbing member 806 is fixedly mounted to the mounting member 804, and there are four shock-absorbing members 806, the four shock-absorbing members 806 being fixedly mounted to four corners of the mounting member 804. Each of the shock-absorbing members 806 may be made of an elastic material, for example, a plastic material, a rubber material, or the like. Each of the shock-absorbing members 806 may be a shock-absorbing strut, a shock-absorbing ball, or the like. It may be understood that, in some other embodiments, a quantity of the shock-absorbing members 806 may be increased or decreased according to an actual requirement, as long as there is at least one.

The photographing device 200 includes a lens mount 210 and a lens 220. The lens 220 is fixedly mounted to the lens mount 210 and accommodated in the through hole 1042. The lens mount 210 is fixedly mounted to the first fixing portion 204. The lens mount 210 is cylindrical and sleeved on the first fixing portion 204. In the present embodiment, there is one lens 220. It may be understood that in some other embodiments, the number of the lenses 220 may be increased according to actual needs, as long as there is at least one. For example, there are two lenses 220, and the two lenses 220 are mounted side by side to the lens mount 210. Correspondingly, the second barrel body 104 is provided with two through holes 1042, and each of the lenses 220 is accommodated in a corresponding one of the through holes 1042.

When the first motor 20 operates, the first fixing portion 204 drives the photographing device 200 to rotate around the first rotation axis. When the second motor 30 operates, the second fixing portion 304 drives the lens barrel 10, the connecting member 42, the first motor 20 and the photographing device 200 to rotate around the second rotation axis. When the third motor 50 operates, the third fixing portion 504 drives the wire 70, the support assembly 40, the lens barrel 10, the first motor 20, the second motor 30 and the photographing device 200 to rotate around the third rotation axis.

It may be understood that, in some other embodiments, the third motor 50 may be omitted, and the support assembly 40 is directly mounted to the shock-absorbing assembly 80.

In the present embodiment, the wire 70 penetrates through the support assembly 40 and the lens barrel 10, so that occupied space of the gimbal 100 may be saved, and the gimbal 100 has a compact structure and a small volume.

Another embodiment of the present invention further provides an unmanned aerial vehicle (UAV), the UAV including a fuselage and the photographing assembly 300 provided in the foregoing embodiment, and the shock-absorbing member 806 being mounted to the fuselage.

Finally, it should be noted that: the foregoing embodiments are merely used for describing the technical solutions of the present invention, but are not intended to limit the present invention. Under the ideas of the present invention, the technical features in the foregoing embodiments or different embodiments may also be combined, the steps may be performed in any order, and many other changes of different aspects of the present invention also exists as described above, and these changes are not provided in detail for simplicity. Although the present invention is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of the present invention.

What is claimed is:

1. A gimbal, comprising:
a first motor configured to carry a photographing device and drive the photographing device to rotate around a first rotation axis;
a lens barrel configured to accommodate the photographing device, the first motor being mounted to the lens barrel;
a second motor is mounted to the lens barrel and configured to drive the lens barrel, the first motor and the photographing device to rotate around a second rotation axis, wherein the first rotation axis is perpendicular to the second rotation axis;
a support assembly, the lens barrel and the second motor being both mounted to the support assembly; and
a wire penetrating through the support assembly and the lens barrel and electrically connected to the first motor and the photographing device.

2. The gimbal according to claim 1, wherein the first motor is accommodated in the lens barrel.

3. The gimbal according to claim 2, wherein the support member comprises a support member and a connecting member,
the connecting member being movably mounted to the support member and being fixedly mounted to the lens barrel, and the connecting member and the lens barrel being capable of rotating around the second rotation axis relative to the support member; and
the second motor being fixedly mounted to the support member.

4. The gimbal according to claim 3, wherein the lens barrel is provided with a first wiring hole;
the support member is provided with a wiring channel;
the connecting member is provided with a second wiring hole, the second wiring hole being respectively in communication with the first wiring hole and the wiring channel; and
the wire sequentially penetrates through the wiring channel, and then the second wiring hole and the first wiring hole enter the lens barrel.

5. The gimbal according to claim 4, wherein the support member comprises a support body, a first support arm and a second support arm,
the first support arm and the second support arm respectively extending from two opposite sides of the support body;
the second motor being fixedly mounted to the first support arm; and
the connecting member being movably mounted to the second support arm, and the connecting member and the lens barrel being capable of rotating around the second rotation axis relative to the second support arm.

6. The gimbal according to claim 5, wherein the second support arm is provided with a mounting hole; and
the connecting member comprises a body portion and an extending portion,
the body portion being fixedly mounted to the lens barrel; and
the extending portion extending from the body portion, being inserted into the mounting hole and being capable of rotating around the second rotation axis relative to the second support arm in the mounting hole.

7. The gimbal according to claim 6, wherein the body portion and the extending portion are both hollow cylinders, and a central axis of the body portion and a central axis of the extending portion both overlap with the second rotation axis.

8. The gimbal according to claim 1, wherein an outer contour of the lens barrel is cylindrical, and a central axis of the lens barrel overlaps with the second rotation axis.

9. The gimbal according to claim 1, wherein the lens barrel comprises a first barrel body and a second barrel body, the first motor being fixedly mounted to the first barrel body, and the first barrel body being engaged with the second barrel body.

10. The gimbal according to claim 1, wherein the first motor comprises a first rotating portion and a first fixing portion,
the first rotating portion being movably connected to the first fixing portion and being fixedly mounted to the lens barrel; and
the first fixing portion being configured to carry the photographing device, and being capable of rotating around the first rotation axis together with the photographing device relative to the first rotating portion.

11. The gimbal according to claim 1, wherein the second motor is disposed outside the lens barrel and comprises
a second rotating portion and a second fixing portion,
the second rotating portion being movably connected to the second fixing portion and being mounted to the support assembly; and
the second fixing portion being mounted to the lens barrel and being capable of rotating around the second rotation axis together with the lens barrel, the first motor and the photographing device relative to the second rotating portion.

12. The gimbal according to claim 1, further comprising a third motor, the support assembly being mounted to the third motor, the third motor being configured to drive the support assembly, and the second motor, the first motor, the lens barrel and the photographing device to rotate around a third rotation axis, and the third rotation axis being perpendicular to the first rotation axis and the second rotation axis.

13. The gimbal according to claim 12, wherein the third motor comprises a third rotating portion and a third fixing portion,
the third rotating portion being movably connected to the third fixing portion, and the third fixing portion being mounted to the support assembly and being configured to drive the support assembly, the second motor, the first motor, the lens barrel and the photographing device to rotate around the third rotation axis.

14. The gimbal according to claim 13, further comprising a shock-absorbing assembly, the third rotating portion being fixedly mounted to the shock-absorbing assembly.

15. The gimbal according to claim 14, wherein the shock-absorbing assembly comprises a fixing member, a mounting member and a shock-absorbing member,
the fixing member being mounted to the third rotating portion;
the mounting member being mounted to one end of the fixing member; and
the shock-absorbing member being mounted to the mounting member.

16. The gimbal according to claim 15, wherein the fixing member is a hollow cylinder and sleeved on the third rotating portion.

17. The gimbal according to claim 15, wherein the shock-absorbing member is a shock-absorbing strut or a shock-absorbing ball.

18. The gimbal according to claim 15, wherein the mounting member is square plate-shaped; and
four shock-absorbing members are fixedly mounted to four corners of the mounting member.

19. A photographing assembly, comprising: a photographing device and the gimbal according to claim 1, the photographing device being mounted to the first motor.

20. The photographing assembly according to claim 19, wherein the photographing device comprises a lens mount and at least one lens,
the at least one lens being fixedly mounted to the lens mount; and
the lens mount being mounted to the first motor.
